(19) United States
(12) Patent Application Publication
(10) Pub. No.: US 2007/0260600 A1
(43) Pub. Date: Nov. 8, 2007

(54) INFORMATION DISCOVERY AND GROUP ASSOCIATION

(75) Inventors: Ben Turner, Chevy Chase, MD (US); John Evans, Ashburn, VA (US); Anthony Renzette, Ashburn, VA (US)

Correspondence Address: GREENBERG TRAURIG, LLP, 1750 TYSONS BOULEVARD, 12TH FLOOR, MCLEAN, VA, 22102, US

(73) Assignee: MITA Group, Washington, DC (US)

(21) Appl. No.: 11/745,924

(22) Filed: May 8, 2007

Related U.S. Application Data
(60) Provisional application No. 60/746,759, filed on May 8, 2006.

(51) Int. Cl. G06F 17/30

(52) U.S. Cl. 707/5

(57) ABSTRACT

A system for associating a plurality of subscribers and a plurality of information assets with one another using a lexicon, each asset or subscriber containing or associated with one or more keywords or key phrases, wherein the subscribers attempt to access the information assets by inputting keywords or key phrases. The system has extractor which extracts words and phrases from information assets and subscriber input, and an analyzer selects keywords and key phrases from the words and phrases output by the extractor, which are in turn used to create a lexicon of keywords and key phrases. The system also has a fingerprint creator which creates a data fingerprint for each information asset and for each subscriber using, at least in part, keywords and key phrases contained in the lexicon. Lastly, the system has a clustering engine which clusters information assets and subscribers with other information assets or subscribers.

This application claims priority from U.S. Provisional Patent Application Ser. No. 60/746,759 filed May 8, 2006, which is incorporated herein by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of online subscriber based information services, and in particular to subscriber based information services that deliver targeted content to its subscribers.

### BACKGROUND OF THE INVENTION

The Internet provides a wide array of information content and online communities. Unfortunately, for an individual user, the amount of information can be overwhelming. While there may exist a wide variety of materials that an individual user may have interest in, such materials are often buried in a much larger group of only marginally related materials. In online communities as well, while such communities may offer focused discussion groups on single topics, users may have a difficult time locating other members with a larger array of similar interests.

For the purposes of the present application the term “information service” is intended to refer to any online service including, without limitation, web sites and bulletin boards accessible through the internet, which provide information in digital format to users of such services.

For the purposes of the present application the term “subscriber” is intended to refer to a user of an information service who has registered with the service and has been assigned a user ID by the service.

For the purposes of the present application the term “subscriber based information services” is intended to refer to an information service which requires a user to register as a subscriber before allowing the user full access to the information content of the service.

For the purposes of the present application the term “assets” is intended to refer to any kind of digital information stored or distributed by an information service such as, without limitation, documents, alerts, feed items, articles, messages, and other forms of digital media, as well as links to digital information stored or distributed by other information services.

For the purposes of the present application the term “keyword” is intended to refer to any word that can be used as a reference point for finding other words or information.

For the purposes of the present application the term “key phrase” is intended to refer to any combination of words that can be used as a reference point for finding other words or information.

For the purposes of the present application the term “lexicon” is intended to refer to a set of keywords and key phrases that can be used to describe attributes of assets and subscribers.

For the purposes of the present application the term “fingerprint” is intended to refer to a set of keywords and key phrases that can be used to describe the attributes of a single asset or a single subscriber. Additionally or alternatively, a fingerprint may include additional information. For example, a fingerprint may include key phrase frequency analysis data, source geography data (e.g., the geographic location of the source of an asset), source site data (e.g., the domain or organization that hosts the source of an asset), author data, user feedback data (e.g., explicit user ratings, inferred user ratings, usage frequency, etc.), and date data.

### SUMMARY OF THE INVENTION

A system for associating a plurality of subscribers and a plurality of information assets with one another using a lexicon. The system contains a plurality of information assets, each asset containing or associated with one or more keywords or key phrases. The system also contains a plurality of subscribers wherein the subscribers attempt to access the information assets by inputting keywords or key phrases. The system has an extractor which extracts words and phrases from information assets and subscriber input, and an analyzer selects keywords and key phrases from the words and phrases output by the extractor, which are in turn used to create a lexicon of keywords and key phrases comprised of keywords and key phrases selected by the analyzer. The system also has a fingerprint creator which creates a data fingerprint for each information asset and for each subscriber using, at least in part, keywords and key phrases contained in the lexicon. Lastly, the system has a clustering engine which clusters information assets and subscribers with other information assets or subscribers that have similar data fingerprints.

### BRIEF DESCRIPTION OF THE DRAWINGS

FIG. 1 is a high level schematic of an embodiment of the system described in the detailed description.

FIG. 2 is a schematic of an embodiment of the process used to create the lexicon.

FIG. 3 is a schematic of an embodiment of the process used to create asset fingerprints.

FIG. 4 is a schematic of an embodiment of the process used to create subscriber fingerprints.

FIG. 5 illustrates the categories of data that may be used in an embodiment of the process used to create a subscriber fingerprint.

FIG. 6 illustrates the categories of data that may be retrieved in response to a subscriber query by an embodiment of the system.

FIG. 7 illustrates an embodiment of the processes used to create and modify asset and subscriber fingerprints.

FIG. 8 illustrates the categories of data that may be automatically recommended to an individual subscribers by an embodiment of the system.

FIG. 8 illustrates the categories of data that may be automatically recommended to an individual subscribers by an embodiment of the system.

FIG. 9 is a schematic of an embodiment of data clustering that may occur within an embodiment of the system.

FIG. 10 illustrates the categories of data that may be automatically recommended to multiple subscribers by an embodiment of the system.

### DETAILED DESCRIPTION OF THE PREFERRED EMBODIMENT

Reference will now be made in detail to the preferred embodiments of the present invention, examples of which are illustrated in the accompanying drawings.

The present invention is described below with reference to block diagrams and operational illustrations of methods and devices to store and/or access information assets. It is understood that each block of the block diagrams or operational illustrations, and combinations of blocks in the block diagrams or operational illustrations, may be implemented by means of analog or digital hardware and computer program instructions. These computer program instructions may be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

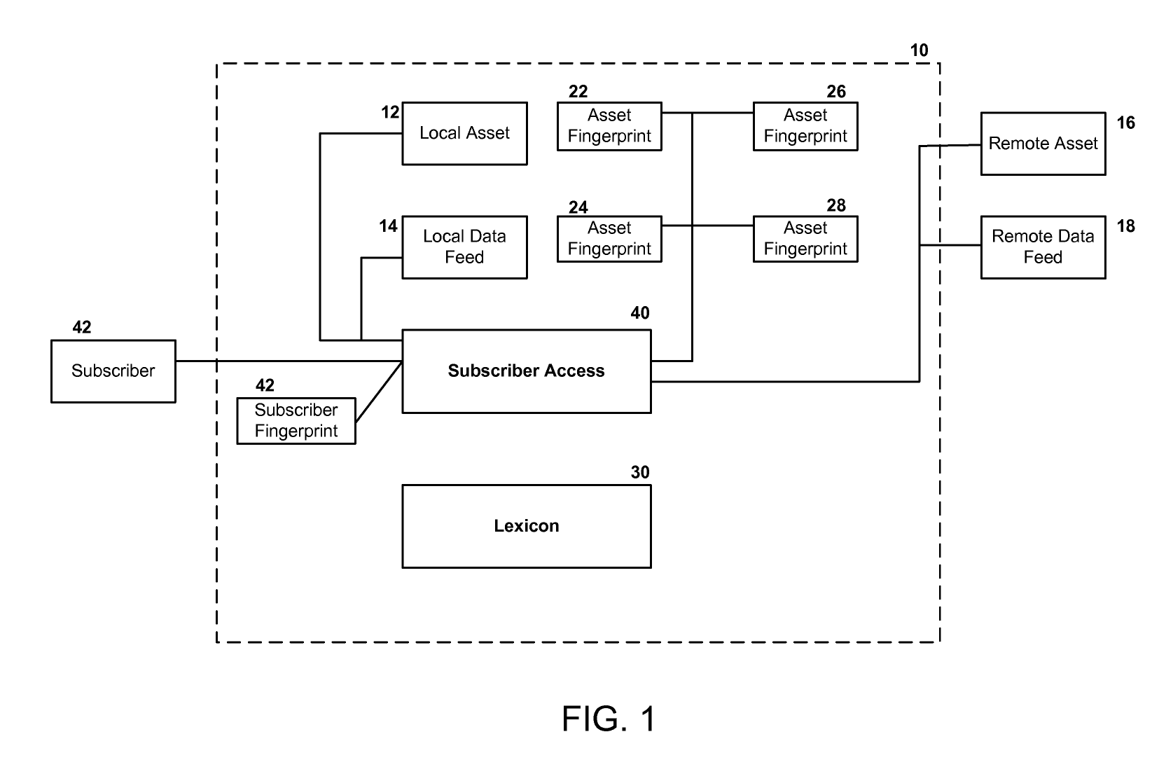

In the embodiment shown in FIG. 1, the system, 10, contains assets, 12, 14, and 16 that are accessible online to users of the service. The assets may be stored locally by the service, 12, may be stored by another information service and linked to by the service, 14, or may be a real-time feed generated by the service, 16, or supplied by another information service, 18. Each asset is associated with data fingerprint, 22, 24, 26, and 28 each data fingerprint being comprised of, in part, keywords and key phrases contained in, or associated with assets, 12, 14, 16 and 18 respectively, and which are also contained in the system's lexicon, 30. The lexicon, 30, contains keywords and key phrases that the system has determined are effective in grouping assets in categories.

Subscribers, 42, are able to log onto the system through a subscriber access process, 40, using credentials that serve to identify the subscriber, for example, a user ID and password. Each subscriber is also associated with a data fingerprint, 44, each data fingerprint being comprised of, in part, keywords and key phrases which describe the subscriber, for example, city of residence, and which are also contained in the system's lexicon, 30. The data fingerprint may also contain keywords and key phrases extracted from activities the user engages in on the service, for example, queries, but only if such keywords and key phrases are on the system's lexicon, 30. The subscriber access component enables subscribers to access assets and other subscribers known to the system using, for example, simple queries or browsing operations. Optionally the subscriber access process, 40, may also use the fingerprints associated with assets and subscribers to filter query results or automatically recommend assets or subscribers that may be of interest to the subscriber, as more fully described below.

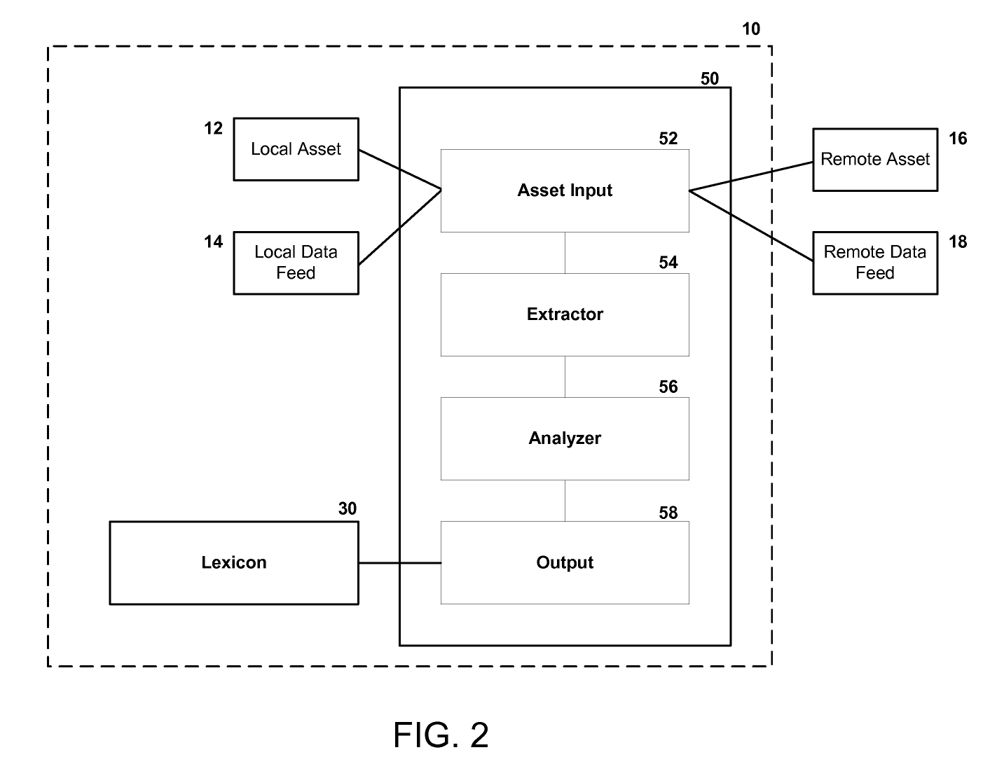

Referring next to FIG. 2, the lexicon is built by a lexicon builder process, 50. The lexicon is derived solely from keywords and key phrases contained in, or associated with, assets. In the first step of the lexicon building process, a group of assets of any type are accessed by an input process within the lexicon builder, 52. Next, words and phrases are extracted from the contents of the assets by an extractor process, 54. Words may be defined as, without limitation, individual tokens composed of one or more characters, bounded by white space. Phrases may be defined as, without limitation, word patterns composed of two or more words.

After all words and phrases have been extracted from the assets, an analyzer process, 56, identifies the frequency with which individual words and phrases. Words and phrases the are found too frequently in assets to be useful to describe assets (e.g., the articles “the” and “a”) and words and phrases that are found too infrequently in assets to be useful to describe assets are discarded. The result is a set of keywords and key phrases, 28, that may be useful for describing the asset. The keywords and key phrases are added to the lexicon by an output process, 58.

As assets are added and removed from the system, it may be appropriate to update the lexicon. In one embodiment, the lexicon builder process could run periodically, inputting all active assets within the system, or, alternatively, inputting all assets of a specific type, or all assets added since the last time the lexicon was updated. In another embodiment, the lexicon builder process could run in real time, and as assets are added, or deleted, the input and extraction process, 52, and 54, runs for individual assets, followed by execution of the analyzer process for the entire set of words and phrases for all assets.

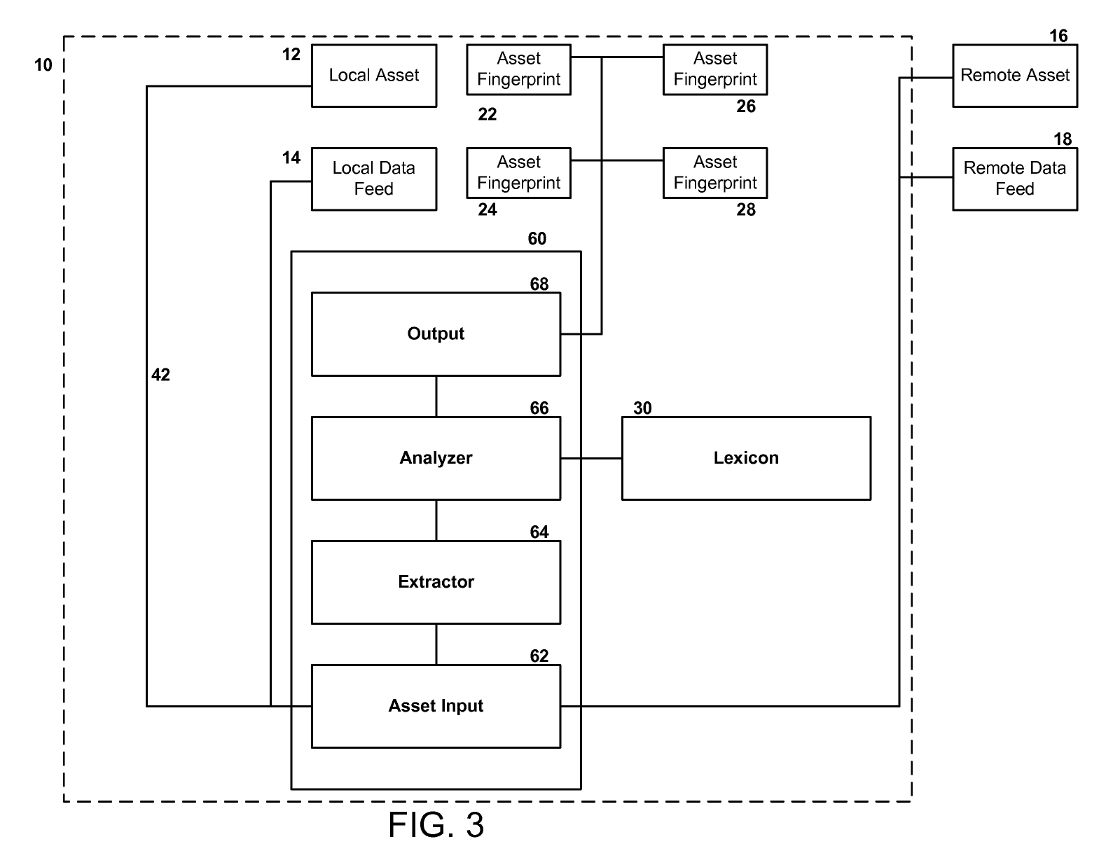

Referring next to FIG. 3, in one embodiment, asset fingerprints are built by an asset fingerprint builder process, 60. In the first step of the process, an asset is accessed by an input process within the asset fingerprint builder process, 62. Next, words and phrases are extracted from the contents of the asset with the assets by an extractor process, 64. The extractor process, 64, discards any words or phrases that are not contained in the systems lexicon, 40. Optionally, an associated information process, 65, gathers information related to the asset, for example source geography data (e.g., the geographic location of the source of an asset), source site data (e.g., the domain or organization that hosts the source of an asset), author data, user feedback data (e.g., explicit user ratings, inferred user ratings, usage frequency, etc.), and date data.

An analyzer process, 66, then inputs the extracted keywords, key phrases, and associated information and uses it to build asset fingerprints. The content of the fingerprint contains information that allows assets to be readily retrieved by simple queries and that also allows assets that pertain to related subjects, for example, a geographic area or a type of food, to be grouped together. In one embodiment, the fingerprint simply contains keywords and key phrases from the lexicon. In another embodiment, the fingerprint may also include key phrase frequency analysis data. In another embodiment, the fingerprint may also contain associated information, such as, for example, geographic origin. The asset fingerprint is then output by an asset fingerprint output process, 68, that associates the fingerprint with the applicable asset.

It may be appropriate, from time to time, to update the asset fingerprint. For example, if the lexicon changes significantly over time, it may be advisable to run the asset fingerprint builder process, 60, for all assets on a periodic basis. Alternatively, the asset fingerprint builder process, 60, could run for an individual asset every time it is accessed.

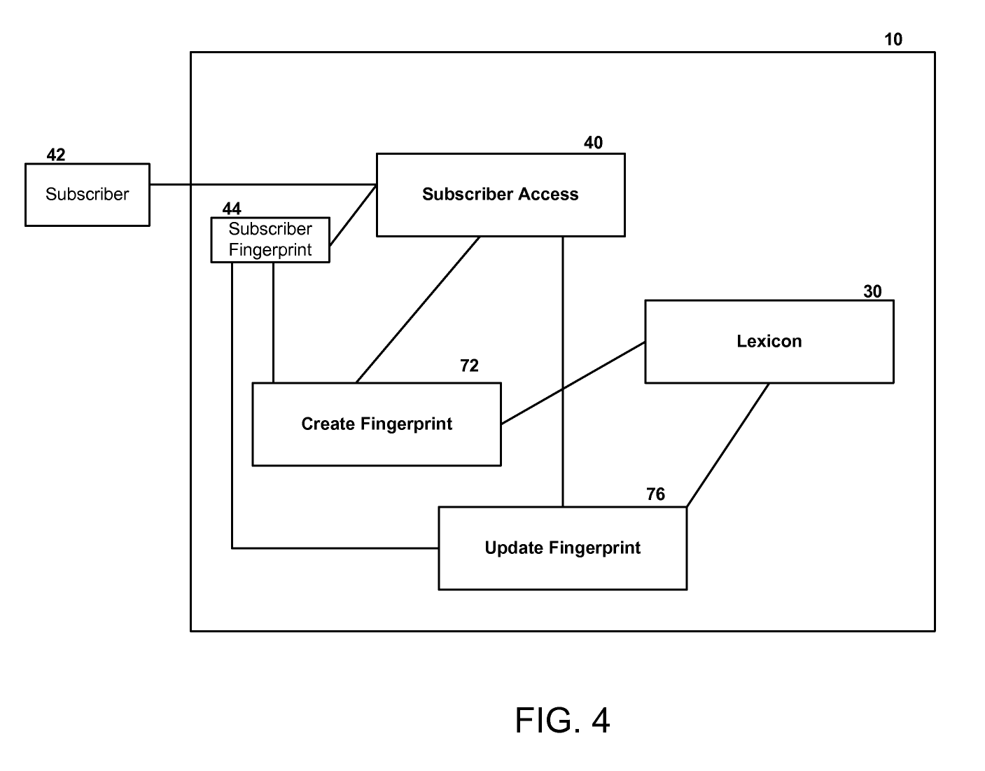

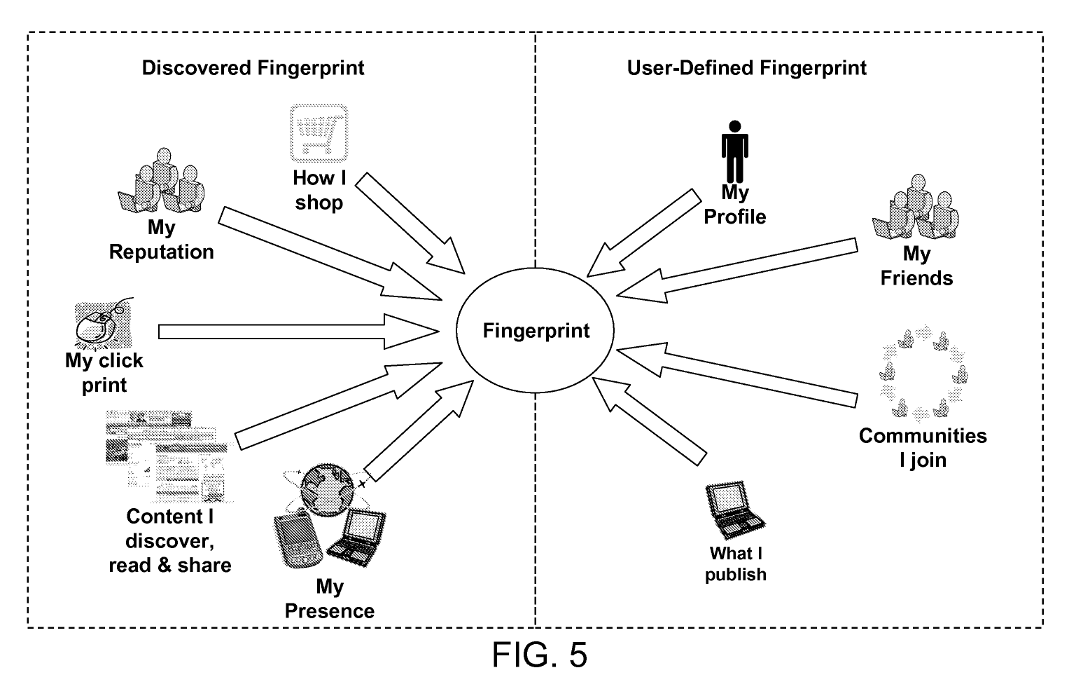

Referring next to FIG. 4, in one embodiment, subscriber fingerprints are built and maintained by processes invoked by the subscriber access component, 40, of the system, 10. When a subscriber first joins the service, an initial fingerprint, 44, is defined by a create initial fingerprint process, 72. In one embodiment, the fingerprint is initially blank. In another embodiment, see FIG. 5, the fingerprint may contain subscriber defined data, such as the subscriber's basic profile, containing, for example, demographic information, the subscriber's friends, hobbies, interests, the online communities the subscriber has joined, and materials the subscriber has published. Referring back to FIG. 4, upon creation of the fingerprint, 44, the fingerprint is then associated with applicable subscriber. If keywords or key phrases are initially placed in the fingerprint, they must be keywords or key phrases from the lexicon, 30.

Optionally, the subscriber fingerprint may be updated on a real-time basis (a “discovered fingerprint”) by an update fingerprint process, 76, invoked by the subscriber access component, 40, of the system, 10. which updates the subscriber fingerprint with data derived from the subscriber's activity on the system. For example, see FIG. 5. A subscriber's fingerprint may be modified based on the fingerprints of assets the subscriber has viewed or otherwise interacted with. Additionally or alternatively, when a subscriber accesses or shares an asset, key phrases appearing in the accessed or shared asset may be added to the subscriber's fingerprint. Additionally or alternatively, when a subscriber enters a query containing keywords or key phrases present in the query may be added to the fingerprint. Note, however, if keywords or key phrases are inserted in the subscriber's fingerprint, they must be keywords or key phrases from the lexicon, 30. Additionally or alternatively, key phrases recently added to the subscriber's fingerprint may be assigned greater weight than key phrases previously added to the subscriber's fingerprint.

Using the same lexicon to define fingerprints that describe both assets and subscribers may allow (1) assets to be compared to other assets; (2) assets to be compared to subscribers; and (3) subscribers to be compared to other subscribers. Such comparisons can be accomplished using a clustering engine that clusters related assets. In one embodiment, the clustering engine could be a component of the subscriber access component, for example, 40 of FIG. 4. Alternatively, the clustering engine could be a separate component invoked by the subscriber access component.

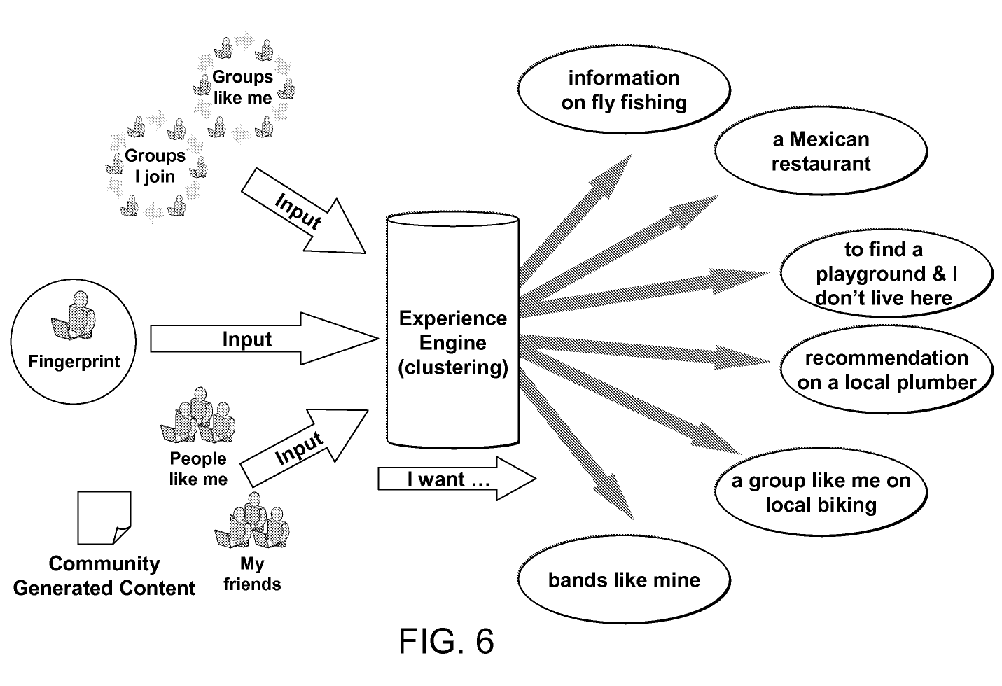

Referring next to FIG. 6, where a subscriber enters a search or a query, the clustering engine may use the fingerprints of other assets and subscribers to identify clusters of assets and subscribers which are related to the topic of interest. For example, the clustering engine could identify a cluster of reviews, articles, or subscriber recommendations for local restaurants.

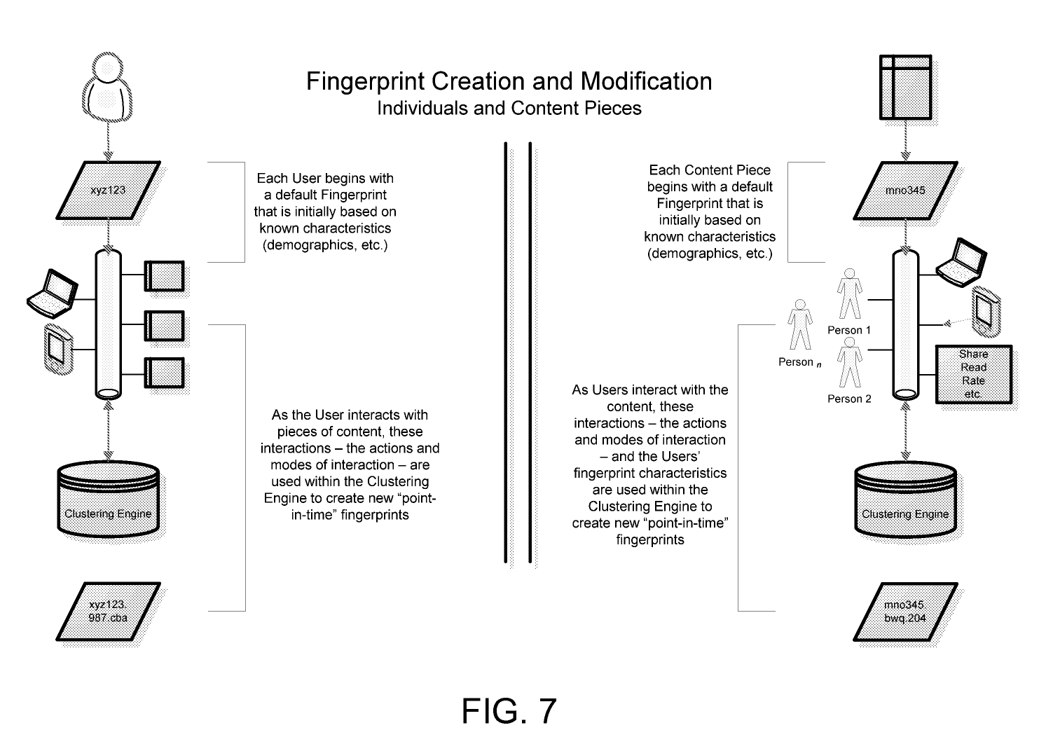

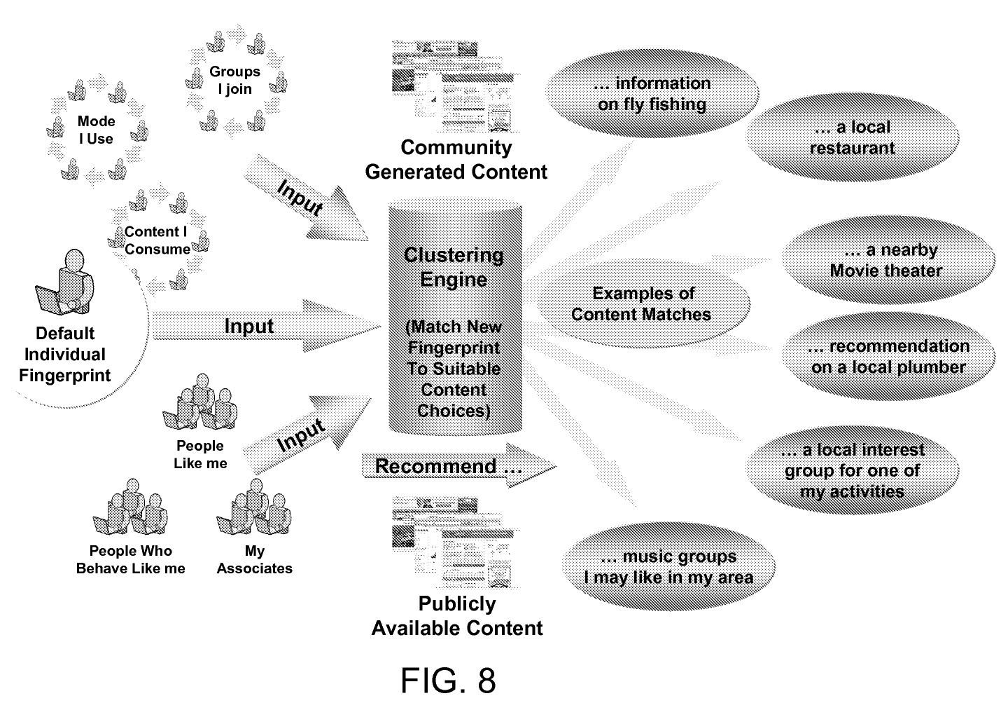

Referring next to FIG. 7, the clustering engine may dynamically update the fingerprint of assets and subscribers as subscriber consumes, shares, rates, or otherwise interacts with assets and other subscribers. Starting with an initial or default fingerprint, which may be based, for example, on based on demographics, the clustering engine uses behavioral observations (inputs) to generate a new point-in-time fingerprint for assets and subscribers. Referring next to FIG. 8, as the subscriber's point-in-time fingerprint changes, the clustering engine may dynamically recommend new assets and subscribers to the subscriber.

In order to facilitate the comparison of assets to assets, assets to subscribers, and subscribers to subscribers, relevancy scores may be determined by assigning different weights to different components of an asset's fingerprints and/or a subscriber's fingerprint. Relevancy scores may be used to determine a subscriber's interest in an asset or another subscriber. For example, if a subscriber's fingerprint shows a high asset relevancy for articles from the New York area with the phrase “Italian Restaurants,” the clustering engine may discover other assets and/or subscribers with a similar set of fingerprint characteristics and assign these assets and subscribers higher relevancy scores relative to the subscriber.

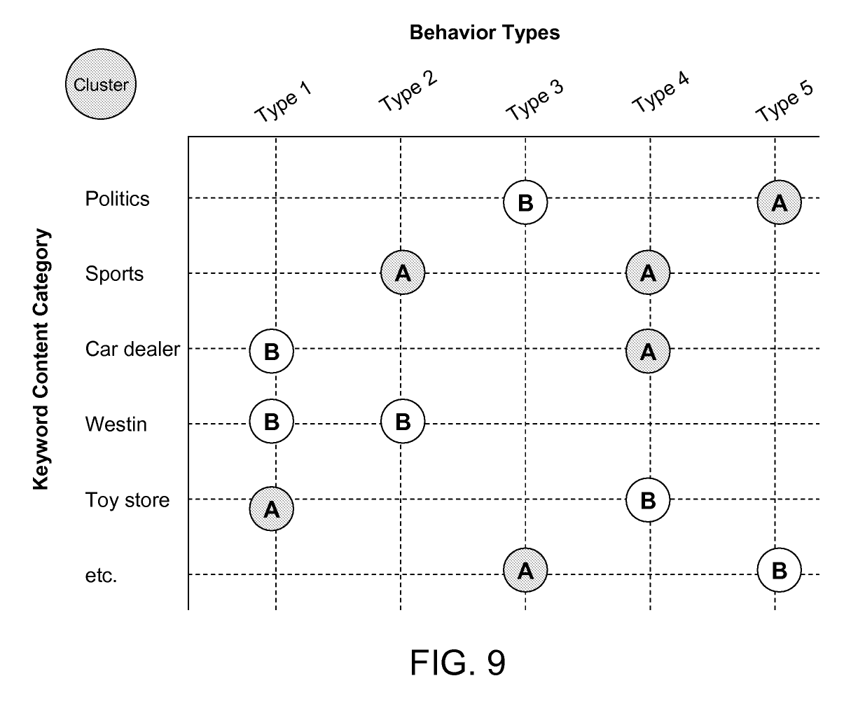

Referring next to FIG. 9, subscribers with similar fingerprints may share similar interests. Thus, clusters of subscribers that potentially share similar interests may be generated dynamically by comparing multiple subscribers' fingerprints and grouping subscribers with similar fingerprints together. The dynamic clustering of subscribers based upon similar fingerprints may facilitate targeted delivery of content, including, for example, advertising and alerts. Such content be subscriber-preferred in that the subscriber may have explicitly indicated an interest in the content or the system may have inferred an interest in the content based on the subscriber's fingerprint and/or behavior.

In one example, if a subscriber purchases a product in response to an advertisement delivered to the subscriber, the same advertisement may be sent to other subscribers having similar fingerprints. Dynamic clustering allows advertisers to identify, in real time, scalable and relevant groups as the consumers behavior and reference points change. Users will freely and continually move through clusters and simultaneously exist within clusters as their preferences change, as they're exposed to new content, as we watch/learn from their behavior and as users interact with other users and pass along new content.

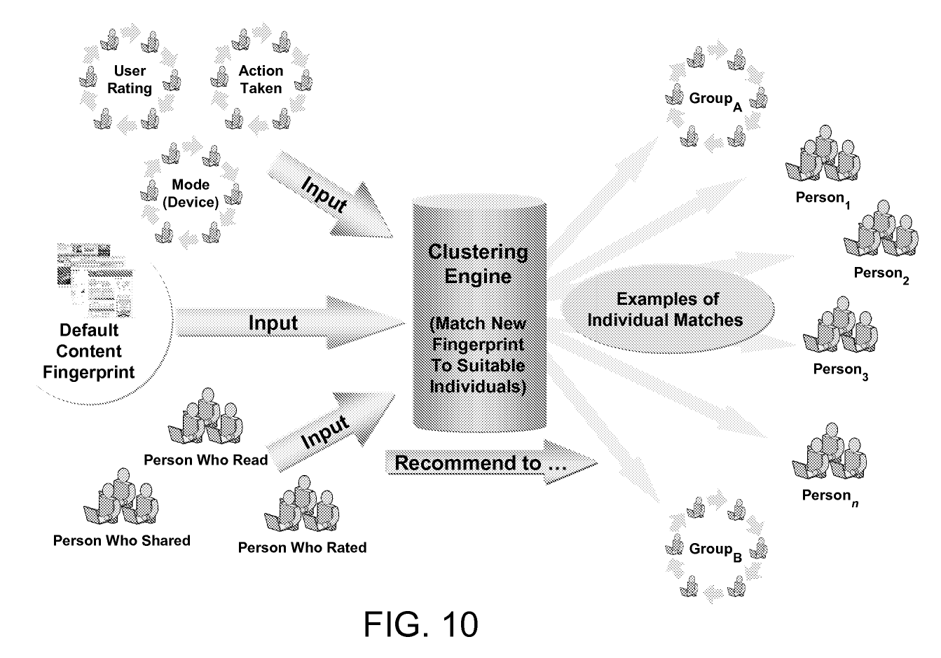

Referring next to FIG. 10, the dynamic clustering of subscribers based upon similar fingerprints also may facilitate the discovery and delivery of highly pertinent content to subscribers. For example, if a subscriber consistently accesses assets from a particular source, it may be determined that another subscriber having a similar fingerprint also may be interested in assets provided by the particular source. Consequently, assets from the particular source may be delivered to a second subscriber having a similar fingerprint. The second subscriber's response to the unsolicited delivery of such assets may be used as feedback to refine the second subscriber's fingerprint.

Additionally or alternatively, the second subscriber's response may be used as feedback for determining whether to continue delivering the asset to other users having similar fingerprints. For example, if the second subscriber deletes the asset without first accessing the asset, it may be inferred that the second subscriber is not interested in the asset and the asset may not be delivered to other subscribers having similar fingerprints. In contrast, if the second subscriber accesses the asset or accesses and shares the asset with other subscribers, it may be inferred that the second subscriber is interested in the asset and the asset may be delivered to other subscribers having similar fingerprints. In another example, the second subscriber may be allowed to rate the content of the asset and the rating assigned to the asset by the second subscriber may be used as a basis for determining whether to deliver the asset to other users having similar fingerprints.

Subscriber activity may be monitored to discover new sources of relevant information for subscribers with similar fingerprints. For example, if a subscriber consistently accesses content from a particular source, it may be determined that other subscribers having similar fingerprints may find assets provided by the particular source interesting and assets from the particular source may be delivered to the other subscribers having similar fingerprints.

A subscriber who receives unsolicited content based on the subscriber's association with other subscribers may be allowed to assign a rating to the received content, and the assigned rating may be used as a basis for determining whether or not to further share the content with other subscriber's associated with the subscriber.

Comparing the fingerprint of an asset to the fingerprint of the subscriber also may be used to prevent delivery to the subscriber of assets that the subscriber may find irrelevant and/or offensive. For example, a spam email filter may be implemented by comparing incoming email messages with the subscriber's fingerprint and refusing to deliver to the subscriber incoming emails that are not within a threshold level of similarity to the subscriber's fingerprint. The subscriber also may set threshold values for relevancy scores in order to filter content the subscriber may find irrelevant/uninteresting.

While the invention has been particularly shown and described with reference to a preferred embodiment thereof, it will be understood by those skilled in the art that various changes in form and details may be made therein without departing from the spirit and scope of the invention.

We claim:

1. A system for associating a plurality of subscribers and a plurality of information assets with one another using a lexicon, comprising:
a plurality of information assets, each asset containing or associated with one or more keywords or key phrases;
a plurality of subscribers wherein the subscribers attempt to access the information assets by inputting keywords or key phrases;
an extractor which extracts words and phrases from information assets and subscriber input;
an analyzer which selects keywords and key phrases from the words and phrases output by the extractor;
a lexicon of keywords and key phrases comprised of keywords and key phrases selected by the analyzer;
a fingerprint creator which creates a data fingerprint for each information asset and for each subscriber using keywords and key phrases contained in the lexicon; and
a clustering engine which clusters information assets and subscribers with other information assets or subscribers that have similar data fingerprints.

2. A method for associating a plurality of subscribers and a plurality of information assets with one another using a lexicon, comprising the steps of:
extracting words and phrases from contained in or associated with information assets;
extracting words and phrases input by subscribers;
selecting keywords and key phrases from the words and phrases extracted from information assets and from subscriber input;
creating a lexicon from the keywords and key phrases extracted from the information assets and subscriber input;
creating data fingerprints for each information asset and for each subscriber using keywords and key phrases contained in the lexicon;
associating information assets and subscribers with other information assets or subscribers having similar data fingerprints.
